(19) United States
(12) Patent Application Publication
(10) Pub. No.: US 2013/0277179 A1
(43) Pub. Date: Oct. 24, 2013

(54) BELT CONVEYER

(71) Applicant: NIPPON ELECTRIC GLASS CO., LTD., Shiga (JP)

(72) Inventors: Yasuo TERANISHI, Takashima-shi (JP); Michiharu ETA, Hikone-shi (JP); Takahide FUJII, Nagahama-shi (JP); Naotoshi INAYAMA, Nagahama-shi (JP)

(21) Appl. No.: 13/858,189

(22) Filed: Apr. 8, 2013

(30) Foreign Application Priority Data
Apr. 20, 2012 (JP) 2012-096613

(51) Int. Cl. B65G 15/30

(52) U.S. Cl. CPC B65G 15/30
USPC 198/834

(57) ABSTRACT

Provided is a belt conveyor (1), comprising: an endless belt (2) for conveying an article (5) loaded thereon; and rotating wheels (3, 4) for stretching the endless belt (2) therearound, wherein contact parts of the endless belt (2) with respect to the rotating wheels (3, 4) are made of glass.

### TECHNICAL FIELD

The present invention relates to a belt conveyor comprising an endless belt for conveying articles loaded thereon, and rotating wheels for stretching the belt therearound.

### BACKGROUND ART

As is well known, a belt conveyor is means for conveying materials, parts, and products, and at present, has been widely used for various purposes in, for example, assembly plants for industrial products. As the belt conveyor, there has been widely employed a type in which a belt which is an endless flexible conveyor belt is driven and pivoted while being stretched around rotating wheels (drive roller and driven roller) such as a pulley and a roller.

Specifically, for example, Patent Literature 1 discloses a belt conveyor including an endless belt made of a thermoplastic resin or a thermoplastic elastomer, and pulleys as rotating wheels for stretching the belt therearound. Patent Literature 1 describes that the thermoplastic resin and the thermoplastic elastomer forming the belt include a vinyl chloride resin and a polyurethane elastomer.

### CITATION LIST

### Patent Literature

Patent Literature 1: JP 2011-121688 A

### SUMMARY OF INVENTION

### Technical Problems

By the way, the belt made of the resin or the elastomer is slid against the pulleys for stretching the belt therearound, and hence a sliding surface thereof is liable to be damaged. Thus, the belt is characteristically liable to generate dust of resin powdery matter and the like. This characteristic causes problems as described below in, for example, a case where the belt conveyor described above is used in a clean room.

Specifically, products to be produced in the clean room, such as a semiconductor integrated circuit, a liquid crystal panel, a plasma panel, and an optical component, are produced by manufacturing steps requiring maintenance of high air cleanliness. Thus, when the dust generated in the clean room is mixed into the products, qualities of the products are adversely affected in various ways.

For example, in the manufacturing step for the semiconductor integrated circuit, when the dust is mixed into the circuit, adjacent patterns are short-circuited. As a result, there occur problems such as a circuit failure, flow of excessive current higher than a designed value into a circuit, and abnormal heat generation in the semiconductor.

Thus, for use in such an environment requiring high air cleanliness, there has been a strong demand for development of a belt conveyor that can suppress generation of dust as much as possible. However, currently, such a demand has not yet been sufficiently met in view, for example, of properties of materials used for components of the belt conveyor.

The present invention has been made in view of the circumstances described above, and it is a technical object thereof to prevent as much as possible dust from being generated from a belt by sliding with respect to rotating wheels during drive of a belt conveyor.

### Solution to Problems

According to the present invention produced to solve the above-mentioned object, there is provided a belt conveyor, comprising: an endless belt for conveying an article loaded thereon; and rotating wheels for stretching the endless belt therearound, wherein contact parts of the endless belt with respect to the rotating wheels are made of glass.

With such a configuration, the contact parts of the endless belt with respect to the rotating wheels are made of glass that has high hardness and flaw resistance. Thus, in comparison with conventional belt conveyors comprising a belt made of a resin or an elastomer, dust can be satisfactorily prevented from being generated from the endless belt by sliding with respect to the rotating wheels. In this case, for example, when the endless belt is formed of a belt-like glass film and an inner peripheral surface of the endless glass film is held in contact with outer peripheral surfaces of the rotating wheels, generation of dust is quite advantageously prevented.

In the above-mentioned configuration, it is preferred that a contact part of each of the rotating wheels with respect to the endless belt be made of an inorganic material.

With this, the inorganic material has flaw resistance, and hence dust can be prevented from being generated not only from the endless belt but also from the rotating wheels when the endless belt and the rotating wheels slide against each other. Thus, it is possible to provide a belt conveyor capable of further reducing generation of dust from the sliding portion therebetween.

In the above-mentioned configuration, it is preferred that a contact part of the endless belt with respect to the article be made of glass.

With this, at the time of loading the article on the endless belt, dust can be prevented from being generated also from the part at which the endless belt and the article come into contact with each other. In this way, all the parts of the belt conveyor, which may generate dust, are appropriately configured.

### Advantageous Effects of Invention

As described above, according to the present invention, it is possible to prevent dust from being generated from the belt by sliding with respect to the rotating wheels during drive of the belt conveyor.

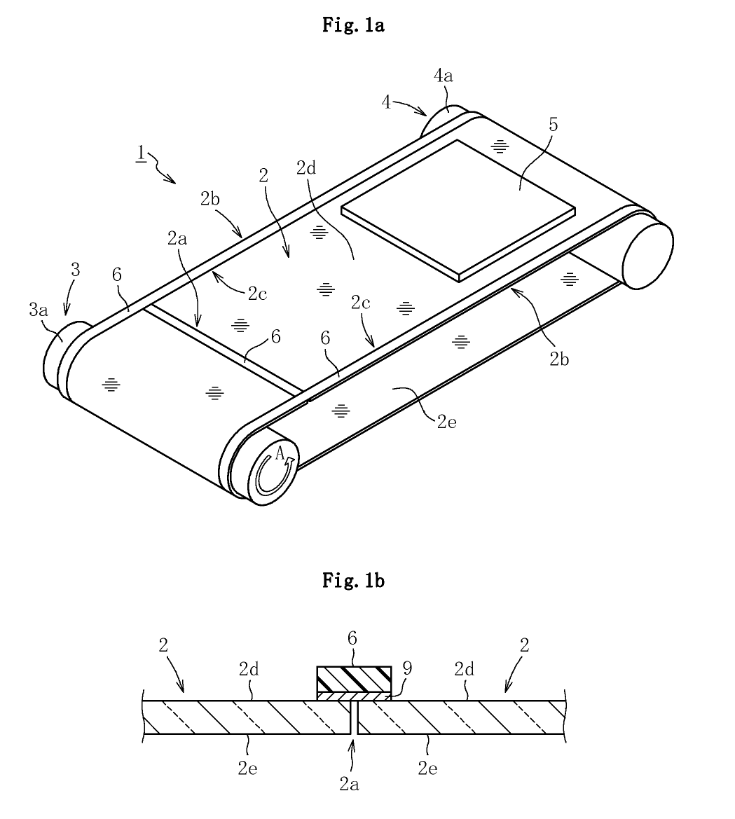

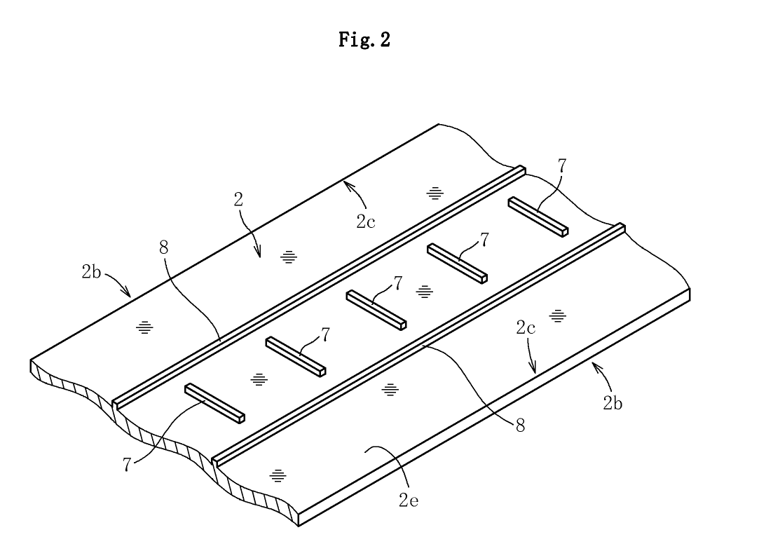

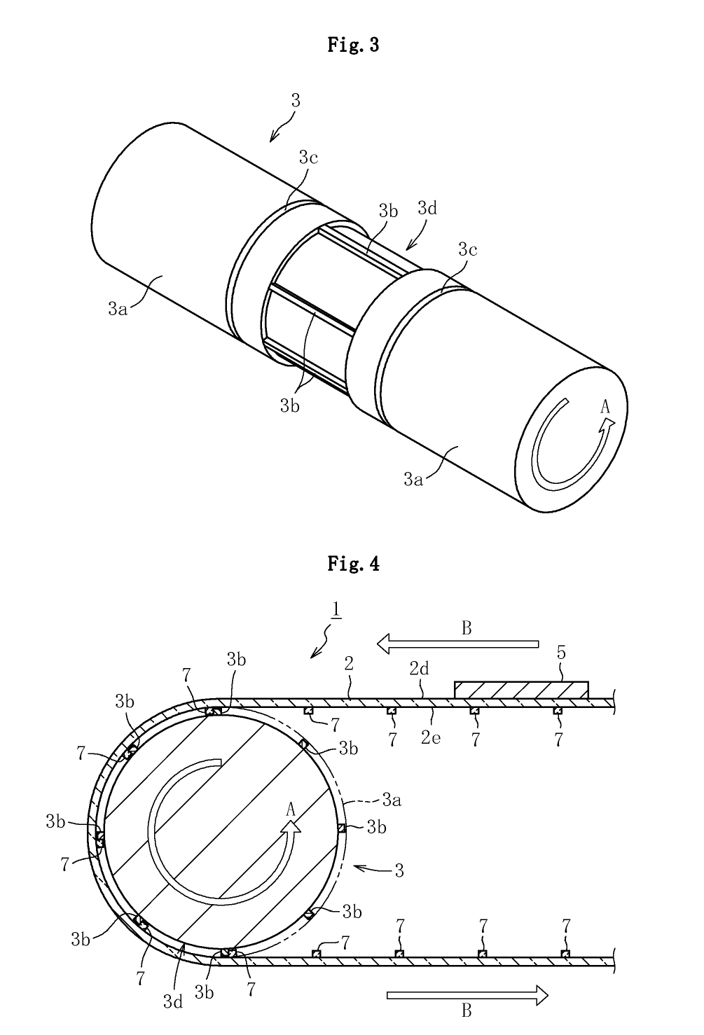

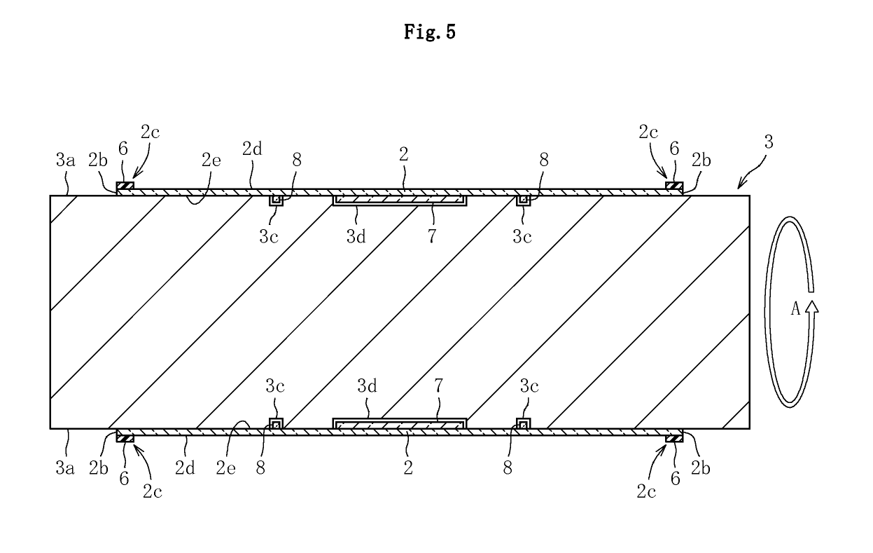

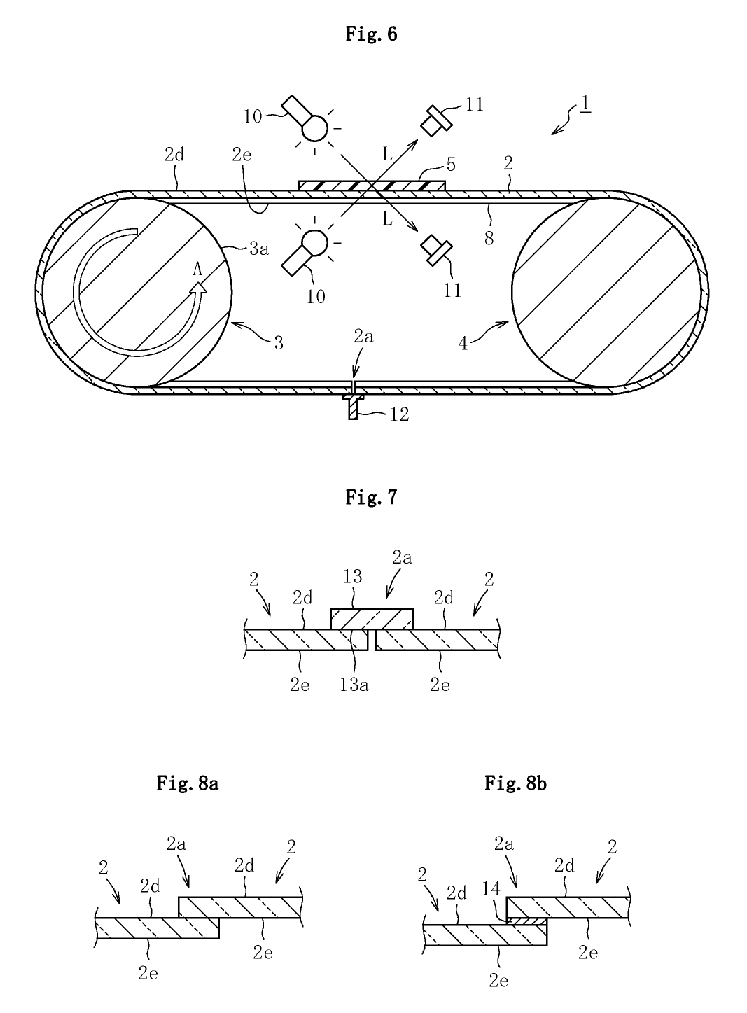

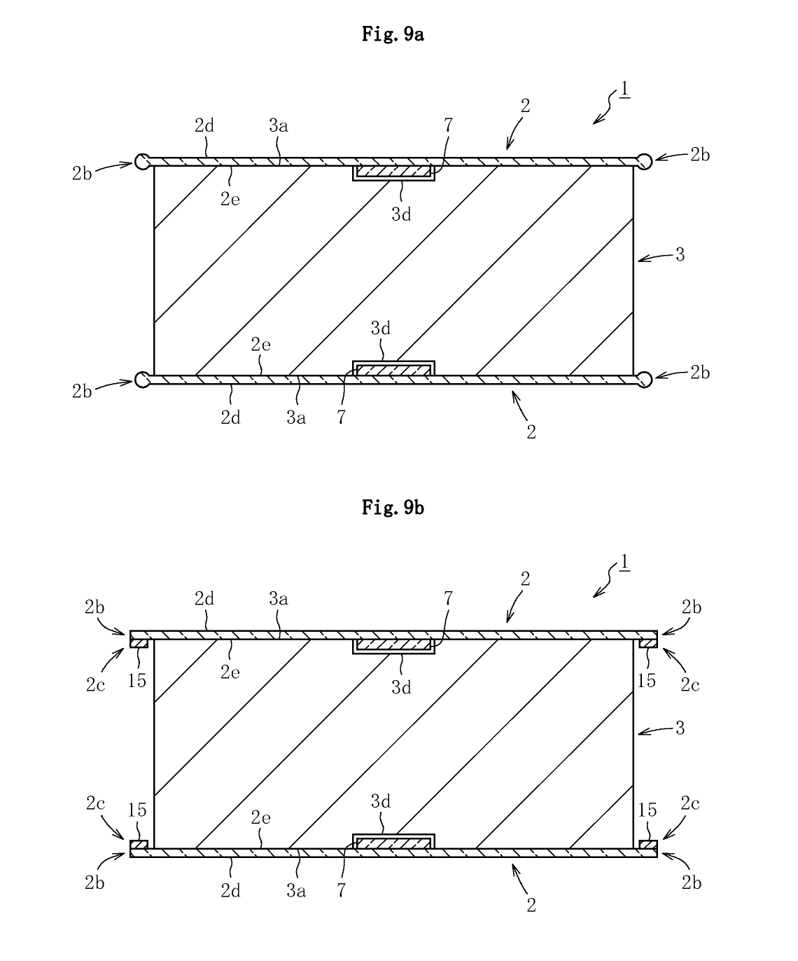

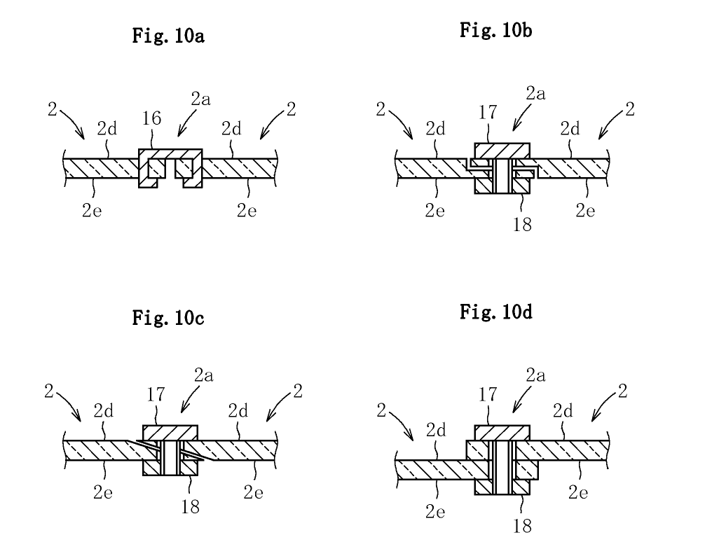

### BRIEF DESCRIPTION OF DRAWINGS

[FIG. 1a] A perspective view of a belt conveyor according to a first embodiment of the present invention.

[FIG. 1b] A side view of a joint portion of a belt provided to the belt conveyor according to the first embodiment of the present invention.

[FIG. 2] A perspective view of a belt provided to a belt conveyor according to a second embodiment of the present invention.

[FIG. 3] A perspective view of a drive roller provided to the belt conveyor according to the second embodiment of the present invention.

[FIG. 4] A side view illustrating conveyance using the belt conveyor according to the second embodiment of the present invention.

[FIG. 5] A front view illustrating the conveyance using the belt conveyor according to the second embodiment of the present invention.

[FIG. 6] A side view of a belt conveyor according to a third embodiment of the present invention.

[FIG. 7] A side view of a joint portion of a belt provided to a belt conveyor according to a fourth embodiment of the present invention.

[FIG. 8a] A side view of a joint portion of a belt provided to a belt conveyor according to a fifth embodiment of the present invention.

[FIG. 8b] Another side view of the joint portion of the belt provided to the belt conveyor according to the fifth embodiment of the present invention.

[FIG. 9a] A front view of a belt conveyor according to a sixth embodiment of the present invention.

[FIG. 9b] Another front view of the belt conveyor according to the sixth embodiment of the present invention.

[FIG. 10a] A side view of a joint portion of a belt provided to a belt conveyor according to another embodiment of the present invention.

[FIG. 10b] A side view of a joint portion of a belt provided to a belt conveyor according to still another embodiment of the present invention.

[FIG. 10c] A side view of a joint portion of a belt provided to a belt conveyor according to yet another embodiment of the present invention.

[FIG. 10d] A side view of a joint portion of a belt provided to a belt conveyor according to yet another embodiment of the present invention.

### DESCRIPTION OF EMBODIMENTS

In the following, description is made of embodiments of the present invention with reference to the attached drawings.

FIG. 1a is a perspective view of a belt conveyor 1 according to a first embodiment of the present invention. As illustrated in FIG. 1a, the belt conveyor 1 comprises an endless belt 2 for conveying an article 5 loaded thereon, and a drive roller 3 and a driven roller 4 serving as rotating wheels for stretching the belt 2 therearound.

In the following description, a surface of the belt 2, on which the article 5 is loaded, is represented as a front surface 2d, and another surface of the belt 2, which is held in contact with the drive roller 3 and the driven roller 4, is represented as a back surface 2e.

The belt 2 is formed of a flexible thin plate glass. The front surface 2d side of a joint portion 2a for jointing both end portions in a longitudinal direction (conveying direction) of the belt 2 to each other so as to form the endless shape, and the front surface 2d side of edge portions 2c respectively continuous with end portions 2b in a width direction of the belt 2 are coated with resin tapes 6. Note that, as illustrated in FIG. 1b, at the joint portion 2a of the belt 2, on the front surface 2d side, a pressure-sensitive adhesive layer 9 is applied over both the end portions facing each other, and the pressure-sensitive adhesive layer 9 is coated with the resin tape 6 thereon. In addition, the pressure-sensitive adhesive layer 9 and the resin tape 6 are applied to coat all over the width direction of the belt 2.

A thickness of the thin plate glass of the belt 2 preferably ranges from 1 μm to 500 μm, more preferably from 10 μm to 300 μm. Further, the resin tapes 6 are preferably made of PET.

The drive roller 3 is formed into a substantially circular columnar shape, and is driven to rotate in a direction A by a motor (not shown). As illustrated in FIG. 1a, the drive roller 3 has a contact surface 3a held in contact with the back surface 2e of the belt 2. Further, the drive roller 3 is made of a ceramics that is an inorganic material. In addition, the driven roller 4 has the same structure as that of the drive roller 3 except that a driving force by the motor is not imparted.

In the following, description is made of conveyance using the above-mentioned belt conveyor 1 according to the first embodiment of the present invention.

As illustrated in FIG. 1a, along with the drive and rotation in the direction A of the drive roller 3, the belt 2 is operated by friction of the contact surface 3a of the drive roller 3 and the back surface 2e of the belt 2. In this way, the article 5 loaded on the belt 2 is conveyed.

At this time, the resin tapes 6 coat only the front surface 2d side of the joint portion 2a and the edge portions 2c of the belt 2, and hence the back surface 2e side of the belt 2 is formed only of glass that has high hardness and flaw resistance. Further, the drive roller 3 held in contact with the back surface 2e is made of a ceramics that has flaw resistance as well. Thus, in comparison with conventional belt conveyors comprising a belt made of a resin or an elastomer, a situation such as generation of dust by sliding of the contact surface 3a and the back surface 2e relative to each other can be suppressed as much as possible.

The advantage described above can be obtained not only between the belt 2 and the drive roller 3, but also between the belt 2 and the driven roller 4 as well.

In addition, as illustrated in FIG. 1a, the article 5 is loaded between a pair of the resin tapes 6 coating the edge portions 2c in the width direction of the belt 2, and hence is not held in contact with any other component of the belt 2 than the glass. Thus, a situation such as generation of dust by collision against the belt 2 at the time of loading the article 5 is satisfactorily prevented as well. For those reasons, even in an environment in which high air cleanliness is required, product failures that may be caused by the dust are suppressed as much as possible.

Further, the resin tapes 6 coating the front surface 2d side of the joint portion 2a and the edge portions 2c of the belt 2 also provide the following advantage. Specifically, even when minute cracks, chips, and the like are formed at the end portions 2b and the edge portions 2c, tensile stress generated by tension to the belt 2 is prevented from concentrating on the minute cracks. Thus, a situation such as breakage of the belt 2 can be reliably avoided.

In addition, at the joint portion 2a, the resin tapes 6 thus provided impart appropriate elasticity to the belt 2 made of glass that inherently has elastic deformation-resistant properties. As a result, the risk of breakage of the belt 2 by the tension to the belt 2 is reduced.

FIG. 2 is a perspective view of the belt 2 provided to the belt conveyor 1 according to a second embodiment of the present invention. Note that, in each of the drawings for illustrating belt conveyors according to second to sixth embodiments below, components having the same functions or shapes as those of the components of the belt conveyor 1 according to each foregoing embodiment are denoted by the same reference symbols so that redundant description thereof is omitted.

The belt conveyor 1 according to the second embodiment is different from the belt conveyor 1 according to the first embodiment described above in the following points. As illustrated in FIG. 2, the back surface 2e of the belt 2 comprises a plurality of ribs 7 for preventing the belt 2 from slipping and for reliably feeding the belt 2, and a pair of guides 8 for preventing the belt 2 from shifting in the width direction. As illustrated in FIG. 3, a recessed portion 3d is provided along a central portion in an axial direction of the drive roller 3, and the recessed portion 3d comprises feeding ribs 3b that mesh with the ribs 7 and operate the belt 2. In addition, a pair of guide grooves 3c for guiding the guides 8 is formed.

The belt 2 and the ribs 7 are held in close contact with each other by surface contact, and the belt 2 and the guides 8 are held in close contact with each other by surface contact as well. The ribs 7 and the guides 8 are each formed of a flexible thin glass, and held in close contact with the back surface 2e of the belt 2 by an adhesive force that is assumed to be generated by a hydrogen bond. Further, the ribs 7 extend parallel to the width direction of the belt 2, and are arranged at an equal pitch along the longitudinal direction thereof. The guides 8 extend in the longitudinal direction of the belt 2, and are arranged parallel to the longitudinal direction.

A thickness of the thin plate glass forming each of the ribs 7 preferably ranges from 100 μm to 1,000 μm, and a thickness of the thin plate glass forming each of the guides 8 preferably ranges from 10 μm to 300 μm. Further, surface roughnesses Ra of contact surfaces of the belt 2, the ribs 7, and the guides 8 are each preferably 2.0 nm or less.

The feeding ribs 3b are provided in the recessed portion 3d formed along the central portion in the axial direction of the drive roller 3, extend along the axial direction, and are arranged along a circumferential direction of the drive roller 3 at a pitch equal to that of the ribs 7 provided to the above-mentioned belt 2. Further, a top portion of each of the feeding ribs 3b and the contact surfaces 3a described above are positioned equidistantly from a rotation axis of the drive roller 3. In other words, the top portion of each of the feeding ribs 3b and the contact surfaces 3a are positioned on a concentric circle.

The guide grooves 3c are formed along the circumferential direction of the drive roller 3, and have a function to introduce the guides 8 provided to the above-mentioned belt 2 into the grooves and guide the guides 8 so as to prevent the belt 2 from shifting in the width direction.

In the following, description is made of conveyance using the above-mentioned belt conveyor 1 according to the second embodiment of the present invention.

FIG. 4 is a side view illustrating conveyance using the belt conveyor 1 according to the second embodiment of the present invention. As illustrated in FIG. 4, along with the drive and rotation in the direction A of the drive roller 3, the feeding ribs 3b provided to the drive roller 3 and the ribs 7 provided to the belt 2 mesh with each other. Then, by the meshing of the feeding ribs 3b and the ribs 7 and the friction of the back surface 2e of the belt 2 and the contact surfaces 3a of the drive roller 3, the belt 2 is operated in a direction B. In this way, the article 5 loaded on the belt 2 is conveyed.

At this time, in addition to the functions and advantages provided by the belt conveyor 1 according to the first embodiment described above, the following advantage can be obtained. Specifically, as illustrated in FIG. 5, when the belt 2 is operated, the guides 8 provided to the belt 2 are guided by being introduced into the guide grooves 3c provided to the drive roller 3. As a result, the belt 2 is prevented from being shifted in the width direction.

FIG. 6 is a side view of the belt conveyor 1 according to a third embodiment of the present invention. The belt conveyor 1 according to the third embodiment is different from the belt conveyor 1 according to the second embodiment described above in comprising light sources 10 for emitting light beams L that are transmitted through the belt 2 and the article 5, and cameras 11 for receiving the transmitted light beams L, and in comprising a protrusion 12 for preventing the article 5 from being loaded on the front surface 2d side of the joint portion 2a of the belt 2.

In the third embodiment, the article 5 to be conveyed by the belt 2 comprises transparent or translucent products and parts, such as a transparent plastic plate. The belt conveyor 1 is configured to apply the light beams L from the light sources 10 to the article 5 while conveying the article 5, and receive the transmitted light beams L with the cameras 11. Then, the light beams L are converted into electrical signals, and the signals are sent to a detection circuit and a determination circuit (none of which is shown). In this way, whether or not internal failures of the article 5 exist is inspected.

In this configuration, the belt 2 is made of glass, and hence is less liable to be flawed in comparison with cases of a resin or an elastomer. In addition, the belt 2 is excellent in abrasion resistance, and hence deterioration in transmittance of the light beams L with respect to the belt 2, which is caused by generation of flaws and progress of abrasion, can be suppressed. With this, the inspection can be satisfactorily performed while avoiding generation of dust. Further, when the article 5 is loaded on the joint portion 2a of the belt 2, the inspection may not be normally performed. However, by the provision of the protrusion 12, the article 5 can be prevented from being loaded on the joint portion 2a.

FIG. 7 is a side view of the joint portion 2a of the belt 2 provided to the belt conveyor 1 according to a fourth embodiment of the present invention. The belt conveyor 1 according to the fourth embodiment is different from the belt conveyor 1 according to the second embodiment described above in that the joint portion 2a is formed by applying not the pressure-sensitive adhesive layer 9 but a thin plate glass 13 over both the end portions in the longitudinal direction of the belt conveyor 1.

A thickness of the thin plate glass 13 preferably ranges from 10 μm to 300 μm, and surface roughnesses Ra of a surface 13a on a side of the thin plate glass 13, which is held in contact with the belt 2, and the front surface 2d of the belt 2 are each preferably 2.0 nm or less. When both the surfaces each having such a low roughness are laminated on each other, an adhesive force is generated between both the surfaces 13a and 2d. The adhesive force is assumed to be generated by a hydrogen bond between both the surfaces 13a and 2d. Further, the thin plate glass 13 is applied over the both the end portions all over the width direction of the belt 2.

Note that, in this case, when both the surfaces 13a and 2d are heated up to 300° C. or more with heat sources such as flame and a laser, the adhesive force between both the surfaces 13a and 2d further increases, with the result that a mechanical strength of the joint portion 2a is increased. This is probably because, in accordance with a rise in temperature of both the surfaces 13a and 2d, a source of generating the adhesive force changes from the hydrogen bond into a covalent bond that generates a much higher adhesive force.

Further, the temperatures of both the surfaces 13a and 2d may be increased by heating up to a melting point of glass or higher. When the temperatures of both the surfaces 13a and 2d are increased up to the melting point or higher so as to melt a part of the glass and then cooling is performed, both the surfaces 13a and 2d can be fused to each other. As a result, the adhesive force between both the surfaces 13a and 2d, and the mechanical strength of the joint portion 2a, which is influenced thereby, are further increased.

In addition, the thin plate glass 13 applied over both the end portions in the longitudinal direction of the belt 2 may be applied not only on the front surface 2d side of the joint portion 2a, but also over each of the front surface 2d side and the back surface 2e side, or over only the back surface 2e side.

FIG. 8a is a side view of the joint portion 2a of the belt 2 provided to the belt conveyor 1 according to a fifth embodiment of the present invention. The belt conveyor 1 according to the fifth embodiment is different from the belt conveyor 1 according to the second embodiment described above in that the joint portion 2a is formed by laminating both the end portions in the longitudinal direction of the belt 2 on each other.

At a part at which both the end portions are laminated on each other, surface roughnesses Ra of surfaces 2d and 2e held in contact with each other are each preferably 2.0 nm or less, and both the surfaces 2d and 2e are held in close contact with each other by the adhesive force that is assumed to be generated by the hydrogen bond. Further, also in this case, as in the fourth embodiment described above, the adhesive force can be increased by heating both the surfaces 2d and 2e up to 300° C. or more, or up to the melting point of glass or higher.

Further, in this case, as illustrated in FIG. 8b, a reinforcing member 14 may be interposed between both the surfaces 2d and 2e so as to increase the adhesive force. As the reinforcing member 14, there may be used various inorganic films such as a film of SiO₂ or Nb₂O₅, organic films, a double-faced tape, and the like. Alternatively, the reinforcing member 14 may be formed by filling a gap between both the surfaces 2d and 2e with an organic adhesive or an inorganic material typified by a low-melting glass, and then performing various processes thereon, such as dehydration, polymerization, and heating.

FIG. 9a is a front view of a belt conveyor 1 according to a sixth embodiment of the present invention. The belt conveyor 1 according to the sixth embodiment is different from the belt conveyor 1 according to the second embodiment described above in the following points. The guides 8 provided to the back surface 2e of the belt 2, the resin tapes 6 provided to the front surface 2d, and the guide grooves 3c provided to the drive roller 3 are removed. A length in the width direction of the belt 2 is larger than a length in the axial direction of the drive roller 3, and the end portions 2b in the width direction are each formed into a circular columnar shape extending along the longitudinal direction of the belt 2.

The shape of the end portions 2b is formed by burning the end portions 2b with a laser or a burner. With this, a part of the glass is molten, and transformed into a rounded shape by surface tension. In such a configuration, a thickness of each of the end portions 2b in the width direction of the belt 2 is larger than those of other parts of the belt 2. Thus, the end portions 2b restrict movement in the width direction of the belt 2. As a result, the belt 2 is prevented from shifting in the width direction.

Further, when the length in the width direction of the belt 2 is larger than the length in the axial direction of the drive roller 3, as illustrated in FIG. 9b, guides 15 each formed of a thin plate glass may be arranged in close contact with the back surface 2e side of the edge portions 2c respectively continuous with the end portions 2b in the width direction of the belt 2. Also with this configuration, the belt 2 is prevented from shifting in the width direction. Note that, in this case, a thickness of each of the guides 15 preferably ranges from 10 μm to 300 μm.

Also with the configurations of the belt conveyors 1 according to the fourth to sixth embodiments described above, dust can be satisfactorily prevented from being generated from the belt 2, the drive roller 3, and the driven roller 4.

The configuration of the belt conveyor according to the present invention is not limited to those described in the embodiments above. For example, the rotating wheel for stretching the belt 2 therearound comprises not only the roller but also a pulley and a sprocket. Further, the belt 2 comprises a belt which is made of a resin, an elastomer, or the like, and on which a belt-like thin plate glass is applied to each of the front surface 2d and the back surface 2e or only to the back surface 2e.

Still further, unlike the embodiments described above, the drive roller 3 and the driven roller 4 each need not be made of a ceramics, and may be formed of various inorganic materials such as various glasses or various metals. In addition, the entirety of each of the drive roller 3 and the driven roller 4 needs not necessarily be made of the various inorganic materials, and only a part (surface) held in contact with the belt 2 may be made of the inorganic materials.

Further, the joint portion 2a for jointing both the end portions in the longitudinal direction of the belt 2 to each other may be formed in other configurations than those described in the embodiments above. For example, as illustrated in FIG. 10a, the joint portion 2a may be formed by jointing both the end portions facing each other in the longitudinal direction of the belt 2 to each other with a stapler 16. Alternatively, the joint portion 2a may be formed by processing both the end portions into various shapes as illustrated in FIGS. 10b and 10c, providing a through-hole in a thickness direction of the belt 2, inserting joint members comprising a bolt 17 and a nut 18 into the through-hole, and jointing the joint members to each other. Still alternatively, as illustrated in FIG. 10d, a through-hole may be provided through both the end portions laminated on each other, and various joint members may be inserted into the through-hole. Further, jointing with the joint portion 2a needs not necessarily be performed over the entire region in the width direction of the belt 2, and the joint portion 2a may intermittently joint both the end portions to each other along the width direction.

In addition, with regard to the resin tapes 6 applied only to the front surface 2d side of the belt 2 in the first to fifth embodiments described above, how to apply the resin tapes 6 is not limited thereto. For example, the resin tape 6 may be folded back at the end portion 2b of the belt 2 so as to coat the end portion 2b and the respective edge portions 2c of the front surface 2d and the back surface 2e, which are continuous with the end portion 2b. Alternatively, the resin tapes 6 may comprise two resin tapes 6 for coating the respective edge portions 2c of the front surface 2d and the back surface 2e. Alternatively, the resin tapes 6 may comprise one or two resin tapes 6 to be applied along the end portions 2b so as to coat the end portions 2b. Also when the resin tapes 6 are applied in those ways, in comparison with conventional belts made of a resin or an elastomer, a contact part between the resin and each of the drive roller 3 and the driven roller 4 is markedly reduced in area. Thus, generation of dust from the sliding portion can be suppressed as much as possible.

In addition, the belt 2 needs not necessarily comprise the resin tapes 6 for coating the edge portions 2c and the joint portion 2a. When the resin tapes 6 are removed, and the joint portion 2a is formed of the stapler 16, a set of the bolt 17 and the nut 18, or various other joint members, the belt 2 has additional advantages of excellent heat resistance and excellent chemical resistance in comparison with the case of being made of a resin or an elastomer. Thus, even when the article 5 is machined or processed while being conveyed by the belt conveyor 1 in, for example, a high-temperature environment, the machining or the process can be satisfactorily performed. Note that, in the high-temperature environment such as inside a heat treatment furnace, the advantages of the belt conveyor 1 can be more satisfactorily yielded in a configuration in which the furnace covers only the belt 2 than in a configuration in which the furnace covers the entire belt conveyor 1.

### REFERENCE SIGNS LIST

1 belt conveyor
2 belt
3 drive roller
4 driven roller
5 article
6 resin tape
7 rib
8 guide
9 pressure-sensitive adhesive layer
10 light source
11 camera
12 protrusion
13 thin plate glass
14 reinforcing member
15 guide
16 stapler
17 bolt
18 nut

1. A belt conveyor, comprising:
an endless belt for conveying an article loaded thereon; and
rotating wheels for stretching the endless belt therearound,
wherein contact parts of the endless belt with respect to the rotating wheels are made of glass.

2. The belt conveyor according to claim 1, wherein a contact part of each of the rotating wheels with respect to the endless belt is made of an inorganic material.

3. The belt conveyor according to claim 1, wherein a contact part of the endless belt with respect to the article is made of glass.

4. The belt conveyor according to claim 2, wherein a contact part of the endless belt with respect to the article is made of glass.
